(19) United States
(12) Patent Application Publication
(10) Pub. No.: US 2015/0060431 A1
(43) Pub. Date: Mar. 5, 2015

(54) ANTI-FOGGING MIRRORS AND METHODS

(71) Applicant: simplehuman, LLC, Torrance, CA (US)

(72) Inventors: Frank Yang, Rancho Palos Verdes, CA (US); David Wolbert, Redondo Beach, CA (US); Guy Cohen, Marina Del Rey, CA (US); Joseph Sandor, Newport Beach, CA (US); Orlando Cardenas, Laguna Niguel, CA (US); Frederick N. Bushroe, Tucson, AZ (US)

(21) Appl. No.: 14/475,045

(22) Filed: Sep. 2, 2014

Related U.S. Application Data
(60) Provisional application No. 61/873,711, filed on Sep. 4, 2013.

(51) Int. Cl. H05B 3/84; F25B 21/02

(52) U.S. Cl. CPC H05B 3/845; F25B 21/02; F25B 2321/02
USPC 219/219; 62/3.2

(57) ABSTRACT

A mirror assembly can include a mirror secured to a housing portion. In some embodiments, the mirror assembly can include a heating element disposed between the housing portion and the mirror. The heating element can heat a surface of the mirror to a pre-determined temperature, preferably above the dew point.

### INCORPORATION BY REFERENCE TO ANY PRIORITY APPLICATIONS

This present application claims priority benefit under 35 U.S.C. §119(e) to U.S. Provisional Application No. 61/873,711, filed Sep. 4, 2013, titled ANTI-FOGGING MIRRORS AND METHODS, which is hereby incorporated by reference in its entirety.

Any and all applications for which a foreign or domestic priority claim is identified in the Application Data Sheet as filed with the present application are hereby incorporated by reference under 37 CFR 1.57.

### BACKGROUND

1. Field

The present disclosure relates to reflective devices, such as mirrors.

2. Description of the Related Art

When the temperature falls below the dew point, water vapor can condense into liquid water on a surface in a manner that resembles fog. This condensation of water can be particularly problematic for mirrors located in bathrooms.

Anti-fog mirrors prevent or eliminate the condensation of water on a mirror surface. However, many anti-fog mirrors are not effective long-term or can take a long time to eliminate the condensation of water on the mirror surface.

### SUMMARY

Certain aspects of this disclosure are directed toward a mirror assembly having a mirror secured to a housing portion. In some embodiments, a mirror assembly can include a temperature-altering device (or two, or three, or more), such as an electrical device, that is configured to alter the temperature of one or more components of the mirror assembly. In some embodiments, the temperature-altering device can produce a first temperature region that is cooler than ambient temperature and a second temperature region that is hotter than ambient temperature. Such devices may be referred to as “thermoelectric coolers,” even though the heating capacity, not the cooling capability, is generally used in some embodiments of this specification to resist the formation of “fog” or water condensation on the mirror assembly. In some embodiments, the temperature-altering device, such as a thermoelectric cooler, is disposed near or in contact with the mirror, and/or is disposed between the housing portion and the mirror. A heating region of the thermoelectric cooler can be configured to heat up, or increase the temperature of, a reflective surface of the mirror to a pre-determined temperature above ambient temperature.

Certain aspects of the present disclosure are directed toward a mirror assembly having a mirror secured to a housing portion. The mirror assembly can include a heating element (or two, or three, or more) disposed between the housing portion and the mirror. The heating element can be configured to heat a surface of the mirror to a pre-determined temperature. In some embodiments, the mirror assembly can include a sensor configured to detect the presence of or movement of an object within a sensing region and an electronic processor configured to generate an electronic signal to signal one or more light sources to activate when the sensor detects the object and/or to activate the mirror-heating element. For example, the sensor can be a proximity sensor. As another example, the sensor can be a tactile sensor.

Certain aspects of the present disclosure are directed toward a mirror assembly having a mirror secured to a housing portion. The mirror assembly can include a heating element (or two, or three, or more) disposed between the housing portion and the mirror. The heating element can be configured to heat a surface of the mirror to a pre-determined temperature. In some embodiments, the mirror assembly can include one or more light sources and a light path disposed around at least a portion of the mirror, such as around the periphery or circumference of the mirror. The light path can be configured to receive light from the one or more light sources and distribute the light generally consistently along a length of the light path. For example, the light path can include a light scattering region along the length of the light path. The light scattering region can have a pattern density. The light scattering region can be configured to encourage a portion of the light impacting the light scattering region to be emitted out of the light path. The pattern density can be less dense in a region generally adjacent the light source and the pattern density can be greater in a region spaced away from the light source, such as spaced away in a generally opposite region from the light source, along the periphery of the mirror. In certain embodiments, the mirror assembly can include a diffuser to diffuse the light emitted from the light path.

In some embodiments, the heating element can be a thermoelectric cooler. A surface area of the heating element can be less than or equal to about 10% of a surface area of the mirror. The heating element can be configured to heat a surface of the mirror to a pre-determined temperature greater than or equal to about 26° C. The pre-determined temperature can be adjustable. The heating element can be configured to heat the surface of the mirror to the pre-determined temperature in less than or equal to about two minutes and/or it can consume less than or equal to about five watts of power. In some embodiments, the mirror assembly can include a heat distribution plate disposed between the mirror and the heating element. In some embodiments, the mirror assembly can include a heat insulation plate disposed between the housing portion and the heating element. In some embodiments, the heating element is powered by a battery.

Certain aspects of this disclosure are directed toward a method of manufacturing a mirror assembly. The method can include connecting a mirror and a housing portion, and positioning a heating element (or two, or three, or more) between the mirror and the housing portion. The heating element can be configured to heat a surface of the mirror to a pre-determined temperature. The method can also include disposing a light source at a periphery of the mirror and disposing a light path around at least a portion of the mirror. The light path can be configured to receive light from the one or more light sources and distribute the light generally consistently along a length of the light path. In some embodiments, the method can include disposing a light scattering region along the length of the light path. The light scattering region can have a pattern density. The light scattering region can be configured to encourage a portion of the light impacting the light scattering region to be emitted out of the light path. The pattern density can be less dense in a region generally adjacent the light source and the pattern density can be greater in a region generally spaced a substantial distance away from, such as positioned generally opposite from, the light source along the periphery of the mirror. In some embodiments, the method can include disposing a diffuser around at least a portion of the mirror.

Certain aspects of this disclosure are directed toward a method of manufacturing a mirror assembly. The method can include connecting a mirror and a housing portion, and positioning a heating element (or two, or three, or more) between the mirror and the housing portion. The heating element can be configured to heat a surface of the mirror to a pre-determined temperature. The method can also include configuring a sensor to generate a signal indicative of the presence of an object and configuring an electronic processor to generate an electronic signal to activate one or more light sources. In some embodiments, the sensor can be a proximity sensor or a tactile sensor.

In any of the methods of manufacturing a mirror assembly described herein, the heating element can be a thermoelectric cooler. In some embodiments, the method can include disposing a heat distribution plate between the heating element and the mirror and/or disposing a heat insulation plate between the heating element and the housing portion.

Any feature, structure, or step disclosed anywhere in this specification can be replaced with or combined with any other feature, structure, or step disclosed anywhere else in this specification, or omitted. Further, for purposes of summarizing the disclosure, certain aspects, advantages, and features of the inventions have been described herein. It is to be understood that not necessarily any or all such advantages are achieved in accordance with any particular embodiment of the inventions disclosed herein. No aspects of this disclosure are essential or indispensable.

### BRIEF DESCRIPTION OF THE DRAWINGS

The above-mentioned and other features of the mirror assembly disclosed herein are described below with reference to the drawings of certain embodiments. The illustrated embodiments are intended to illustrate, but not to limit the present disclosure. The drawings contain the following Figures:

FIG. 1 illustrates a perspective view of a mirror assembly.

FIG. 2 illustrates a front view of the mirror assembly shown in FIG. 1.

FIG. 3 illustrates a side view of the mirror assembly shown in FIG. 1.

FIG. 4A illustrates a rear view of the mirror assembly shown in FIG. 1.

FIG. 4B illustrates a rear view of the mirror assembly shown in FIG. 1 disassembled from a rear portion of the mirror assembly.

FIG. 5 illustrates an exploded view of the mirror assembly shown in FIG. 1.

FIG. 6 illustrates an enlarged view of an inner portion of the lower portion of the mirror assembly shown in FIG. 1.

FIG. 7A illustrates a cross-section of the mirror assembly shown in FIG. 2 taken along line 7A-7A.

FIG. 7B illustrates an enlarged view of the cross-section shown in FIG. 7A taken along line 7B-7B.

FIG. 8 illustrates an exemplary embodiment of a heating element.

FIG. 9 is a flow chart illustrating an exemplary algorithm that can be carried out by components of the mirror assembly.

### DETAILED DESCRIPTION

The following discussion is presented to enable a person skilled in the art to make and use one or more embodiments of the invention. The general principles described herein may be applied to embodiments and applications other than those detailed below without departing from the spirit and scope of the invention. Therefore the present invention is not intended to be limited to the embodiments shown, but is to be accorded the widest scope consistent with the principles and features disclosed or suggested herein.

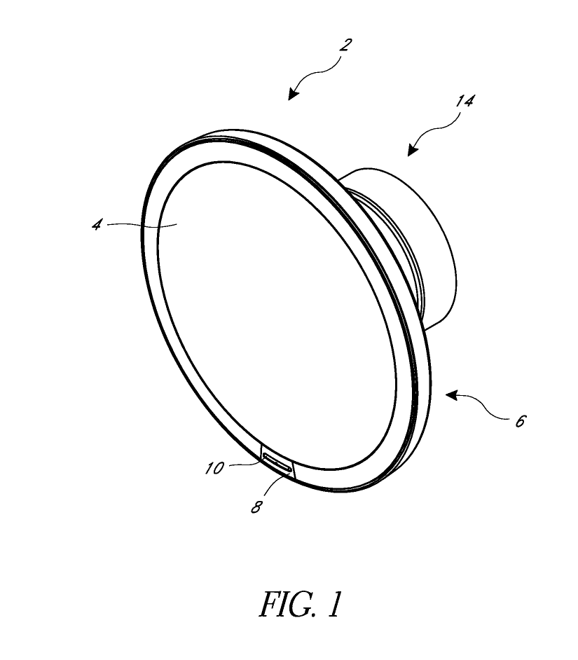

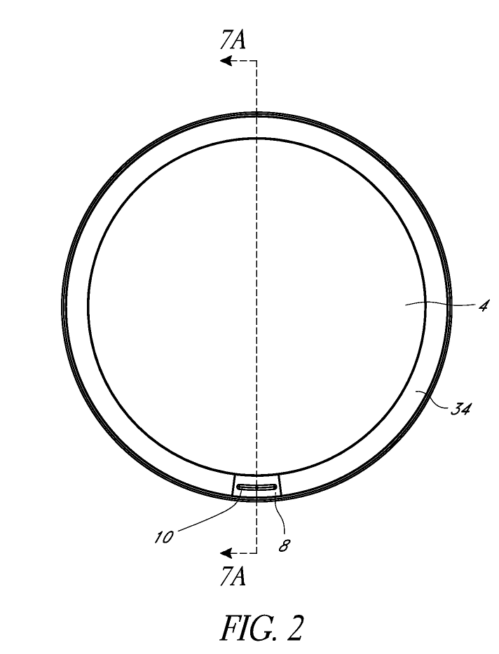

As shown in FIGS. 1 and 2, the mirror assembly 2 can generally include a housing portion 6 and a visual image reflective surface, such as a mirror 4. The mirror assembly 2 can include one or more components to prevent, resist, or mitigate the condensation of water on the mirror 4.

In some embodiments, the mirror assembly 2 can include one or more light sources 26 that transmit light. As will be described in further detail below, the mirror assembly 2 can also include one or more light conveying components. Any of the structures, embodiments, components, steps, or methods relating to mirror components or assemblies disclosed in co-pending U.S. Patent Publication Nos. 2013/0235610 and 2013/0235607, both filed on Mar. 1, 2013, as well as related U.S. Provisional Patent Application No. 61/608,584, filed on Mar. 8, 2012, are contemplated to be useable with or instead of any of the structures, embodiments, components, steps, and methods disclosed in this specification, and all of such applications are incorporated herein by reference in their entireties.

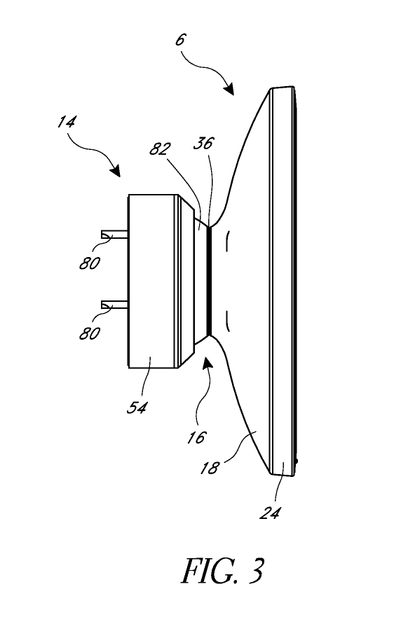

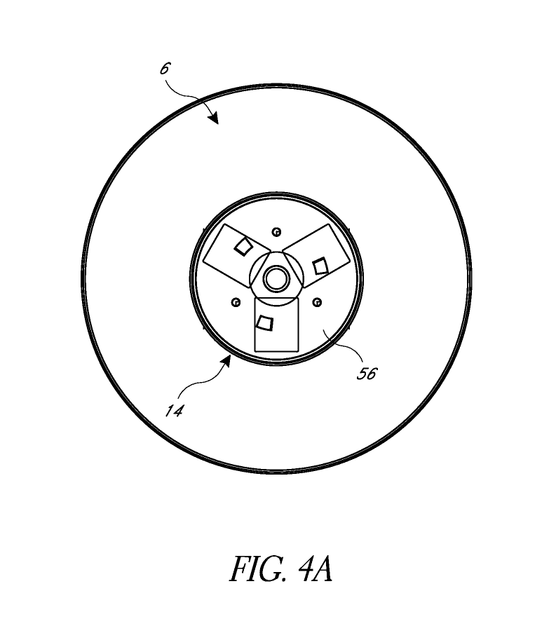

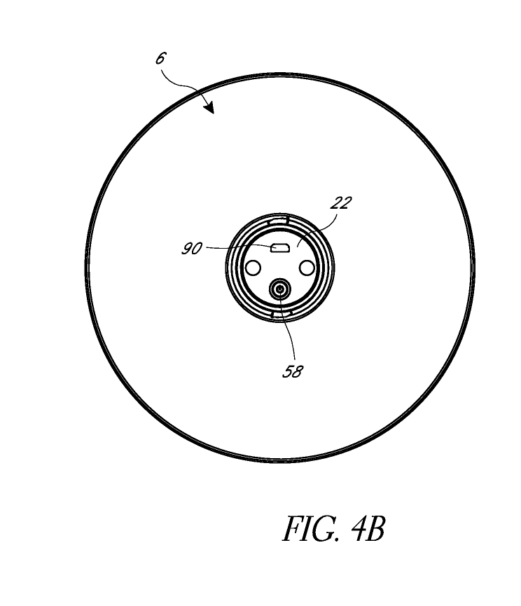

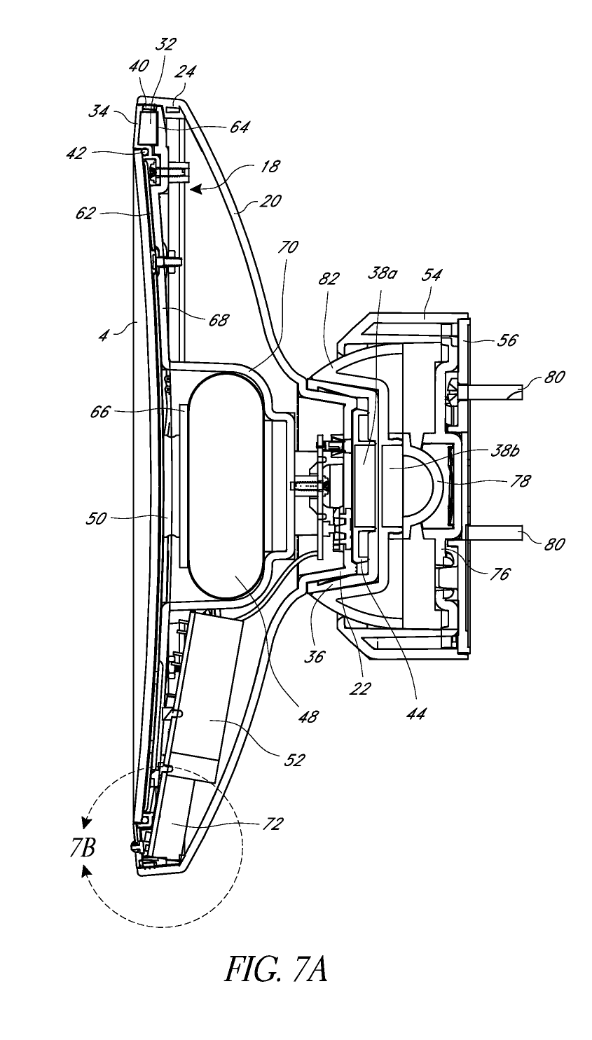

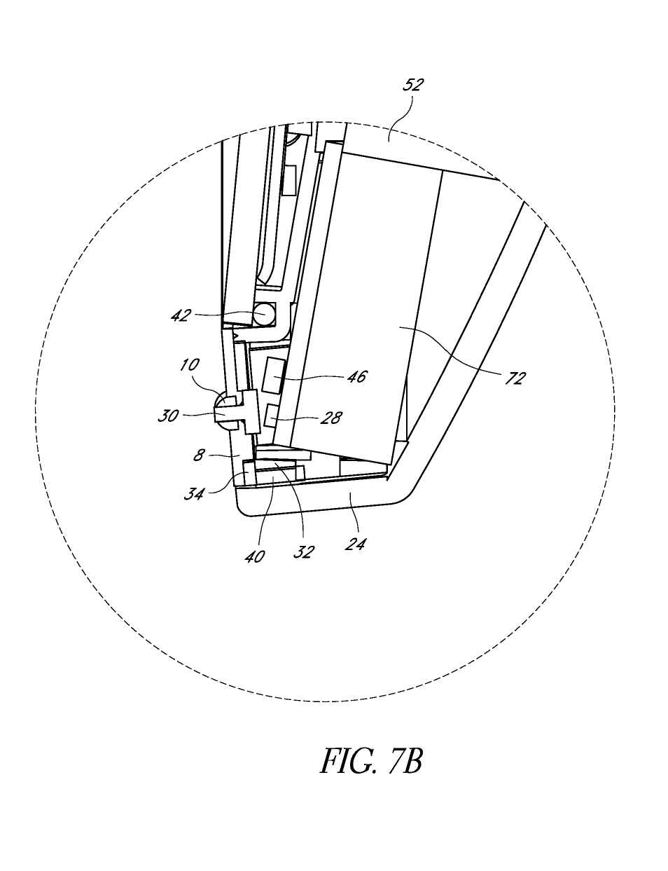

As shown in FIGS. 3 and 4, the mirror assembly 2 can include a wall mount 14 secured to the housing portion 6. The wall mount 14 can include a base portion 54 and a mounting plate 56 that are integrally or separately formed. As shown in FIG. 7A, the mounting plate 56 can engage the base portion 54 with a suitable connector, for example, using a screw fit, a snap fit, an adhesive, magnets, bayonets, detents, clamps, or otherwise.

In use, the wall mount 14 can be configured to be secured to a surface. For example, the wall mount 14 can be secured to the surface using a suitable connector, such as adhesives (e.g., adhesive strips or glue), screws, magnets, or likewise. As another example, the wall mount 14 can be secured to a frame using screws, magnets, slide and lock features, clips, clamps, or otherwise. As shown in FIG. 3, the wall mount 14 can include a number of screws 80 or likewise to secure the mirror assembly 2 to the surface.

In some embodiments, the housing portion 6 can move relative to the wall mount 14. For example, as shown in FIG. 3, the mirror assembly 2 can include a position adjustment portion, such as a joint portion 16, that permits the housing portion 6 to move (e.g., pivot, slide, rotate, etc.) relative to the wall mount 14. For example, the joint portion 16 can be a ball joint that permits smooth movement in all directions. In some examples, the mirror assembly 2 can include a hinge, linkage, and/or other mechanical assembly configured to permit the housing portion 6 to move relative to the wall mount 14.

Although the mirror assemblies described herein are generally disclosed in the context of a wall-mounted mirror, the various aspects of the present disclosure can be used in many other contexts as well, such as free standing mirrors, mirrors mounted on articles of furniture, mirrors mounted on shower caddy or shelving, mirror mounted to shower pipes, hanging mirrors, and otherwise.

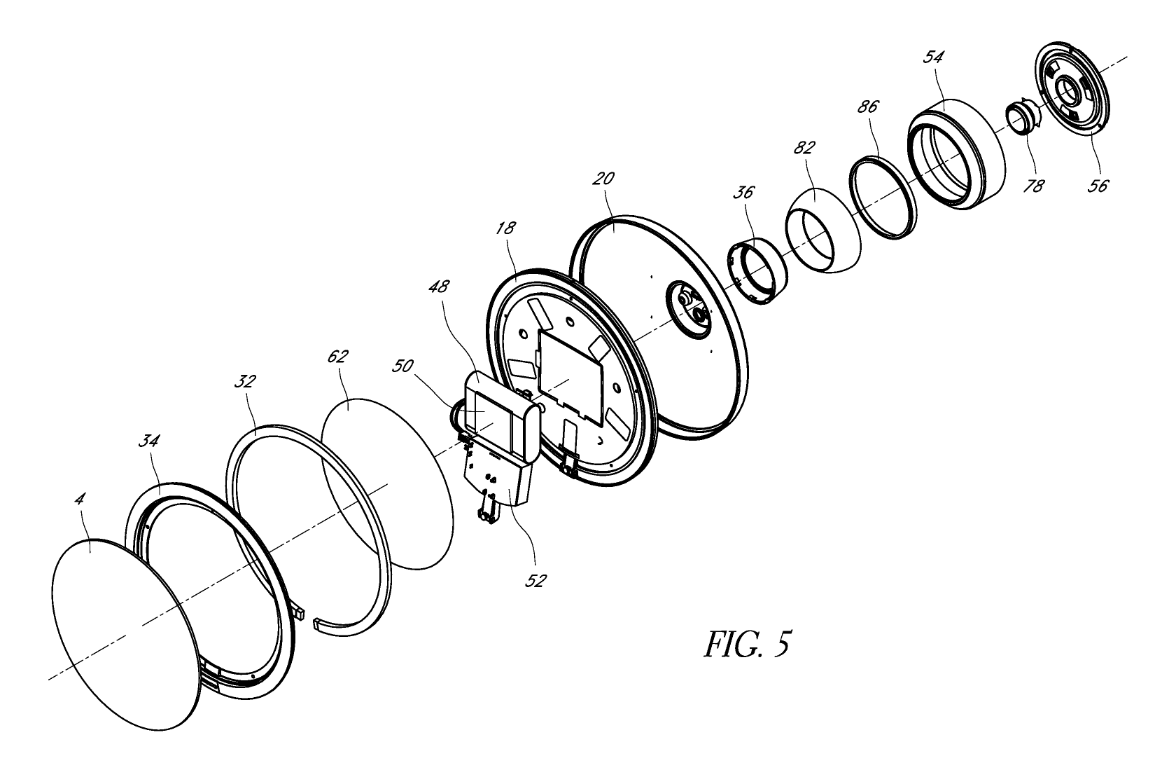

Referring back to the housing portion 6, as shown in FIG. 5, the housing portion 6 can include an inner portion 18 and an outer portion 20. The inner and outer portions 18, 20 can include plastic, metal (e.g., stainless steel, aluminum, etc.), and/or other suitable materials.

The outer portion 20 can generally include a rim portion 24 and a rear portion 22 that are integrally or separately formed (see FIG. 7A). The rim portion 24 can surround at least a majority, substantially all, or the entirety of the mirror 4. The rim portion 24 can include a diameter that is generally greater than a diameter of the rear portion 22. For example, the diameter of the rim portion 24 can be at least about two times, at least about three times, at least about four times, or at least about five times the diameter of the rear portion 22.

The rear portion 22 can be secured to the joint portion 16 and/or the wall mount 14 using suitable connectors, such as adhesives, screws, magnets, a friction fit, or otherwise. As shown in FIG. 7A, the rear portion 22 can be secured to the joint portion 16 using a number of magnets, for example, two magnets 38a, 38b. The rear portion 22 can include a recess for receiving a first magnet 38a, and the joint portion 16 can include a recess for receiving a second magnet 38b. In certain aspects, the mirror assembly 2 can include a magnet holder 44 secured to the rear portion. The magnet holder 44 can include a recess for receiving the magnet 38a. In certain aspects, the magnets 38a, 38b can be generally circular, generally annular, generally rectangular, or any other suitable shape.

As shown in FIG. 7A, the joint portion 16 can include a socket portion 76 disposed within the wall mount 14. The joint portion 16 can also include a ball portion 78 rotatable within the socket portion 76. At least a portion of the ball portion 78 can include a generally spherical surface. For example, as shown in FIG. 5, the ball portion 78 can include a generally hemispherical portion. The ball portion 78 can engage a pivot portion 82. For example, a first end of the pivot portion 82 can include a recess for receiving the ball portion 78. A second end of the pivot portion 82 can engage the rear portion 22 of the outer portion 20. For example, the second end of the pivot portion 82 can include a recess for receiving the rear portion 22.

In some embodiments, the mirror assembly 2 can be water-resistant or water-proof to resist or prevent the ingress of water inside portions of the mirror assembly 2 that could damage or hinder the proper functioning of the mirror assembly 2, including portions containing electronic circuits, a heating element, and/or the power supply. The mirror assembly 2 can include a cap portion 36 disposed between the rear portion 22 and the joint portion 16. As shown in FIG. 7A, the cap portion 36 can be sized and shaped to generally surround the rear portion 22. A portion of the cap portion 36 may be visible between the rear portion 22 and the joint portion 16. The cap portion 36 can include a water-resistant or waterproof material to resist or to prevent the entry of water into the housing portion 6, for example, the cap portion 36 can include rubber, PVC, polyurethanes, silicone elastomers, and/or wax. The cap portion 36 can also facilitate a friction fit between the rear portion 22 and the joint portion 16. In certain aspects, there can be a sealing member, for example, a seal ring disposed between the rear portion 20 and the cap portion 36.

As shown in FIG. 7A, the outer portion 20 can be sized to receive the inner portion 18. The inner portion 18 can include a front portion 68 and a rear portion 70. The front portion 68 can be positioned closer to the mirror 4 than the rear portion 70. The rear portion 70 can include a diameter or outer periphery sized to fit within the rear portion 22 of the outer portion 20. The inner portion 18 can be secured to the outer portion 20 using suitable connectors, such as adhesives, screws, magnets, and/or otherwise. One or more electronic components can be disposed between the inner portion 18 and the outer portion 20.

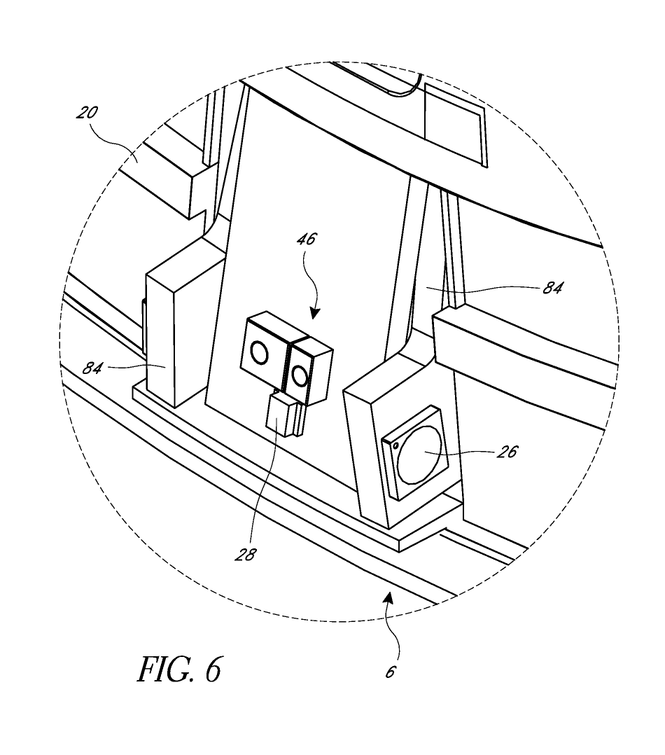

The inner portion 18 can be shaped and sized to receive the mirror 4 and/or a number of light conveying components. For example, as shown in FIG. 6, the inner portion 18 can be configured to receive one or more light sources 26 and/or light conveying components, such as a light pipe 32 and/or a diffuser 34. As shown in FIG. 7A, the diffuser 34 can be secured to the inner portion 18, for example, using a suitable connector, such as adhesives, screws, magnets, and/or otherwise, and the light pipe 32 can be disposed between the diffuser 34 and the inner portion 18.

The mirror assembly 2 can include a number of water-resistant or waterproof seal features disposed between the mirror 4, the light pipe 32, the diffuser 34, the inner portion 18, and/or the outer portion 20. For example, as shown in FIG. 7A, the mirror assembly 2 can include a first seal ring 40 disposed along a first direction between the outer portion 20 and the light pipe 32. The first seal ring 40 can also be disposed along a second direction between the diffuser 32 and the inner portion 18. As another example, the mirror assembly 2 can include a second seal ring 42 disposed between the mirror 4 and the diffuser 34.

As shown in FIG. 1, the mirror 4 can have a generally circular shape. In other embodiments, the mirror 4 can have an overall shape that is generally elliptical, generally square, generally rectangular, or any other shape. In some embodiments, the mirror 4 can have a diameter of at least about 6 inches and/or less than or equal to about 16 inches, for example, between about 6 inches and about 12 inches, or between about 12 inches and about 16 inches. In some embodiments, the mirror 4 can have a diameter of about 6 inches. In some embodiments, the reflective component of the mirror 4 can have a thickness of at least about 2 mm and/or less than or equal to about 3 mm. In some embodiments, the thickness can be less than or equal to about two millimeters and/or greater than or equal to about three millimeters, depending on the desired properties of the mirror 4 (e.g., reduced weight or greater strength). In some embodiments, the surface area of the mirror 4 can be substantially greater than the surface area of the wall mount 14. For example, the area of the image-reflecting surface of the mirror 4 can be at least about two times the diameter of the wall mount 14 and/or less than or equal to about five times the diameter of the wall mount 14.

The mirror 4 can be highly reflective (e.g., has at least about 90% reflectivity). In some embodiments, the mirror 4 can have greater than about 70% reflectivity and/or less than or equal to about 90% reflectivity. In other embodiments, the mirror 4 can have at least about 80% reflectivity and/or less than or equal to about 100% reflectivity. In certain embodiments, the mirror can have within about 3% of about 87% reflectivity. In some embodiments, the mirror 4 can be cut out or ground off from a larger mirror blank so that mirror edge distortions are diminished or eliminated. One or more filters can be provided on or within the mirror to adjust one or more parameters of the reflected light. In some embodiments, the filter can include a film and/or a coating that absorbs or enhances the reflection of certain bandwidths of electromagnetic energy. In some embodiments, one or more color adjusting filters, such as a Makrolon® filter, can be applied to the mirror to attenuate desired wavelengths of light in the visible spectrum.

The mirror 4 can be highly transmissive (e.g., nearly 100% transmission). In some embodiments, transmission can be at least about 90%. In some embodiments, transmission can be at least about 95%. In some embodiments, transmission can be at least about 99%. The mirror 4 can be optical grade and/or comprise glass. For example, the mirror 4 can include ultra-clear glass. The mirror 4 can include other translucent materials, such as plastic, nylon, acrylic, and/or other suitable materials. The mirror 4 can include a backing including aluminum or silver. In some embodiments, the backing can impart a slightly colored tone, such as a slightly bluish tone to the mirror. In some embodiments, an aluminum backing can resist or prevent rust formation and provide a generally even color tone. The mirror 4 can be manufactured using molding, machining, grinding, polishing, or other techniques.

The mirror 4 can include a generally flat or generally spherical surface, which can be convex or concave. The radius of curvature can depend on the desired optical power. In some embodiments, the radius of curvature can be at least about 15 inches and/or less than or equal to about 30 inches. The focal length can be about half of the radius of curvature. For example, the focal length can be at least about 7.5 inches and/or less than or equal to about 15 inches. In some embodiments, the radius of curvature can be at least about 18 inches and/or less than or equal to about 24 inches. In some embodiments, the mirror 4 can include a radius of curvature of about 20 inches and can have a focal length of about 10 inches. In some embodiments, the mirror 4 can include a radius of curvature of about 16 inches and can have a focal length of about 8 inches. In some embodiments, the mirror 4 is aspherical, which can facilitate customization of the focal points.

In some embodiments, the radius of curvature of the mirror 4 is controlled such that the magnification (optical power) of the object can be at least about 2 times larger and/or less than or equal to about 7 times larger. In certain embodiments, the magnification of the object can be about 5 times larger. In some embodiments, the mirror 4 can have a radius of curvature of about 16 inches and/or about 3 times magnification. In some embodiments, the mirror can have a radius of curvature of about 19 inches and/or about 7 times magnification. In some embodiments, the mirror 4 can have a radius of curvature of about 24 inches and/or about 5 times magnification.

As described above, in some instances, it can be desirable for the mirror assembly 2 to include one or more anti-fog components to prevent, resist, or mitigate condensation of water on the image-reflecting surface of the mirror. These anti-fog components can be particularly useful for mirrors configured to be located in bathrooms, showers, cars, or elsewhere, in environments with high moisture content.

For example, as shown in FIG. 5, the mirror assembly 2 can include a heating element 50 (or two, or three, or more) to maintain the temperature of the image-reflecting surface of the mirror at a temperature above the dew point. In certain embodiments, the heating element 50 can maintain the temperature of the image reflecting surface at greater than or equal to about 20° C., greater than or equal to about 25° C., or greater than or equal to about 30° C., for example, within 2° C. of about 26° C., about 28° C., or about 30° C. The heating element 50 can be positioned in thermal communication with the reflective mirror component. For example, the heating element 50 can be disposed behind the mirror 4, for example, between the mirror 4 and a surface of the inner portion 18. In certain aspects, as shown in FIG. 7A, the heating element 50 can be disposed along a central portion of the mirror 4. In some embodiments, the heating element 50 can directly contact the front or back of the reflective mirror component.

The heating element can be different from an incidental heat source located within the mirror assembly 4, such as a heat source created by the natural functioning of electronic components (e.g., heat produced by electrical circuits or the draining of a battery, or heat emitted from a light source, such as an LED light source), since these incidental heat sources can be difficult to control and can be too low or can be intermittent and inconsistent in producing an acceptable level of heat over time. However, in some embodiments, the heating element can be provided by another electronic component within the mirror assembly 4, such as an LED light source, that is appropriately positioned in thermal communication with a mirror surface on which moisture in the air may otherwise condense at a lower temperature.

In some embodiments, the heating element 50 can be a resistive heating element positioned behind the mirror 4. When electric current passes through a conductor in the resistive heating element, the resistive heating element can release heat to raise the temperature of the image-reflecting surface above the dew point.

In some embodiments, the heating element 50 can be a reservoir configured to contain hot water, such as hot water circulated from a hot water source in a shower or sink.

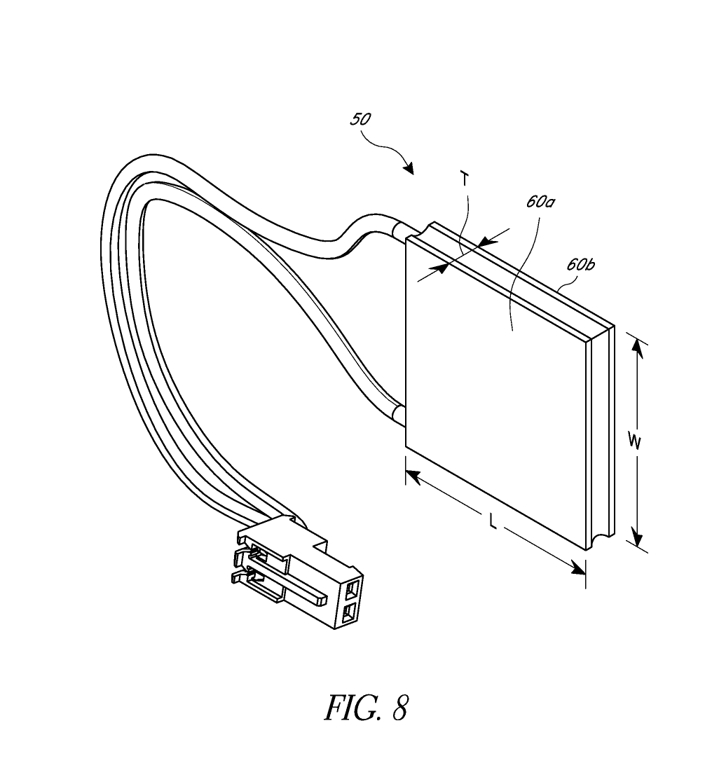

In some embodiments, as shown in FIG. 8, the heating function of the heating element 50 can be provided by a heated surface in a thermoelectric cooler. The heating element 50 can include a first side 60a and a second side 60b. When current flows through the heating element 50, heat from the first side 60a moves to the second side 60b such that the second side 60b is hotter than the first side 60a. In certain embodiments, the temperature difference between the first side 60a and the second side 60b can be at least about 10° C. and/or less than or equal to about 80° C. For example, the temperature difference can be between about 60° C. and about 80° C., between about 65° C. and about 75° C., or about 70° C. In some embodiments, a target temperature of the second side 60b can be at least about 70° C. and/or less than or equal to about 100° C. For example, a target temperature of the second side 60b can be at least about 80° C. or at least about 90° C. In certain embodiments, the target temperature of the second side 60b can be at least about 80° C. and/or less than or equal to about 90° C. In some embodiments, a target temperature of the first side 60a can be at least about −50° C., at least about −25° C., at least about 0° C., at least about 10° C., or at least about 20° C. In certain embodiments, the target temperature of the first side 58 can be greater than or equal to about 10° C. and/or less than or equal to about 20° C.

In some embodiments, once activated, the heating element 50 can reach the target temperature in less than or equal to about two minutes. In some embodiments, the heating element 50 can maintain the target temperature, while consuming less than or equal to about five watts, less than or equal to about three watts, or less than or equal to about two watts.

Thermoelectric coolers can be particularly useful because the target temperature can be controlled to within fractions of a degree. The target temperature can be modified, for example, by changing the input voltage or current. The ability to change the target temperature can be particularly useful because the dew point can change based on humidity and/or ambient temperature. In some embodiments, a temperature sensor unit can sense the ambient temperature and adjust the temperature of the heating element and/or the temperature of one or more components of the mirror assembly 2 accordingly. In some embodiments, the mirror assembly 2 can include a heat sink (not shown) to further control the temperature of the image-reflecting surface.

The heating element 50 can include various materials generally suitable for thermoelectric coolers. For example, the heating element 50 can include alloys, crystals, nanocomposites, or other suitable materials.

The heating element 50 can be sized so as not to significantly increase the size of the mirror assembly 2. For example, a width W of the heating element 50 can be less than or equal to about one-half the diameter of the mirror 4, less than or equal to about one-third the diameter of the mirror 4, less than or equal to about one-fourth the diameter of the mirror 4, or less than or equal to about one-sixth the diameter of the mirror 4. In some embodiments, the width W can be less than or equal to about 1.5 inches, or less than or equal to about 1 inch. In some embodiments, the thickness T of the heating element 50 can be less than or equal to about 0.5 inches, less than or equal to about 0.25 inches, or less than or equal to about 0.2 inches. In some embodiments, the length L of the first or second side 58, 60 can be less than or equal to about one-half the diameter of the mirror, less than or equal to about one-third the diameter of the mirror 4, less than or equal to about one-fourth the diameter of the mirror 4, or less than or equal to about one-sixth the diameter of the mirror. In certain embodiments, the length L of the first or second side can be less than or equal to about 3 inches, less than or equal to about 2.5 inches, less than or equal to about 2 inches, less than or equal to about 1.5 inches, or less than or equal to about 1 inch. In some embodiments, a surface of area of the first or second side 58, 60 can be less than or equal to about 50% of a surface area of the mirror 4, less than or equal to about 25% of a surface area of the mirror, less than or equal to about 15% of a surface area of the mirror, or less than or equal to about 10% of a surface of the mirror. In some embodiments, the surface area of the heating side of the heating element 50 can be generally about the same size as or less than the surface area of the rear of the light-reflecting surface of the mirror 4. In some embodiments, the heating element 50 can be generally square, generally rectangular, generally circular, or otherwise.

Although the figures illustrate a single heating element 50, the mirror assembly 2 can include a plurality of heating elements (e.g., two, three, or more) that each produces a heating region. For example, the heating elements can be spaced equally from a radial center of the mirror 4. The heating elements 50 can be spaced apart enough to produce generally independent heating regions and/or to generally avoid overlapping heating regions and/or to provide an effective overall heating region generated by the heating elements collectively. In some embodiments, substantially the entire reflective mirror surface can be de-fogged.

In some embodiments, the heating element 50 can be used as a thermoelectric generator. The heating element 50 can generate a difference in voltage between the first side 58 and the second side 60b. The generated voltage can be used to help recharge the battery so that the battery drains more slowly or used to separately power illumination or an indicator.

In some embodiments, as shown in FIG. 5, the mirror assembly 2 can include a heat distributing plate 62 to help distribute the heat generally evenly across the mirror 4. The plate 62 can include a material with a high rate of heat conduction, such as a metal (e.g., aluminum, steel, copper, and/or brass).

As shown in FIG. 7A, the plate 62 can be positioned between the mirror 4 and the heating element 50. At least a portion of the plate 62 can be secured to the inner portion 18 of the housing 8. For example, as shown in FIG. 7A, the plate 62 can be secured to the front portion 68 of the inner portion 18 using a suitable connector, such as one or more screws. A periphery of the plate 62 can be secured to the inner portion 18, while a central portion of the plate 62 can be in contact with the heating element 50.

The plate 62 can be sized to distribute heat across at least a majority of, substantially all of, or the entirety of the image reflecting surface of the mirror 4. In some embodiments, the heat can be distributed substantially evenly across these areas or regions. The diameter of the plate 62, or distance across the plate 62, can be less than or equal to about the diameter of, or distance across, the mirror 4. For example, as shown in FIG. 5, a diameter of the plate 62 can be substantially the same as the diameter of the mirror 4. The diameter of the plate 62 can be at least about 90% of the diameter of the mirror 4, or at least about 95% of the diameter of the mirror 4.

In some embodiments, as shown in FIG. 7A, the mirror assembly 2 can include a heat insulation plate 66. The heat insulation plate 66 can insulate the heating element 50 from the battery heat and vice versa. For example, as shown in FIG. 7A, the heat insulation plate 66 can be disposed between the heating element 50 and the battery housing 48. In certain embodiments, a width of the heat insulation plate 66 can be greater than a width W of the heating element 50 but less than a width of the battery housing 48. In certain aspects, the heat insulation plate 66 can include a foam material.

Referring back to the heating element 50, in some embodiments, the heating element 50 can operate constantly when turned on or activated (as described in further detail below). In some embodiments, the mirror assembly 2 can include a power button 58 to power on/off the heating element 50. The power button 58 can be positioned anywhere along the mirror assembly 2. For example, as shown in FIG. 4B, the mirror assembly 2 can include a power button 58 along a rear portion of the housing 6. The power button 58 can be accessed when the wall mount 14 is removed.

In some embodiments, as described in further detail below, the mirror assembly 2 can include one or more sensors, for example, proximity, temperature, moisture, and/or tactile sensors, configured to signal a controller to activate the heating element 50. For example, a temperature sensor can signal the controller to activate the heating element 50 when the temperature is close to the dew point. In some embodiments, the sensor can be a moisture indicator that can send a signal to the controller when a shower is turned on. In some embodiments, the sensor can detect light and signal the controller to activate the heating element when a bathroom light is turned on. In some embodiments, the heating element 50 can be speech or noise activated. In some embodiments, a clock or timer can be configured to activate the heating element 50 at a particular time of day, such as a few minutes before a user normally takes a shower, to permit the mirror assembly 2 to be heated up already when showering begins and the moisture level in the air is increased.

In some embodiments, the heating element 50 can be configured to operate generally continuously so long as one or more conditions are met. For example, the heating element 50 can operate as long as the sensor detects a signal or a range of signals. As another example, the heating element 50 can automatically shut off after a timer elapses or if the sensor does not detect another signal before the timer elapses. The timer can run for at least about ten minutes, at least about five minutes, or otherwise. There can also be a second timer that elapses before the heating element 50 reactivates. As another example, the mirror assembly 2 can include a second deactivation sensor that can send a signal to the controller to deactivate the heating element 50 when the deactivation sensor detects a signal. For example, the deactivation sensor can be a proximity sensor or tactile sensor. The deactivation sensor can be positioned anywhere along the mirror assembly, preferably sufficiently displaced from the sensor that activates the heating element 50. Various other modes of operation or algorithms can be utilized, for example, many of the modes of operation and algorithms described below in connection with the sensor 46 and/or mirror illumination can be adapted for use with the heating element 50.

Although the anti-fog features described herein are generally described in connection with a heating element, other components can be used instead of or in addition to a heating element, to resist or prevent condensation. For example, the mirror 4 can be coated with an anti-fog coating, such as a surfactant film or a hydrophilic coating, or a mechanical anti-fog mechanism can be used, such as a wiper or air blower.

As described above, in some embodiments, the mirror assembly 2 can include one or more light sources 26 that transmit light. The light sources 26 can be positioned such that light is emitted generally toward a user facing the viewing surface of the mirror assembly 2. Some or all of the light from the light sources 26 can be emitted toward the user or be reflected off another component before reaching the user. In some embodiments, the light sources 26 can be positioned behind the mirror 4 (e.g., creating a back lighting effect).

The light sources 26 can be positioned anywhere along the mirror assembly. For example, as shown in FIG. 6, the light sources 26 can be positioned along a lower portion of the mirror assembly 2. The light sources 26 can be positioned below the mirror 4 and within the housing 8. In some examples, the light sources 26 can be positioned along an upper portion of the mirror 4 and/or along a side portion of the mirror 4.

The one or more light sources 26 can include light emitting diodes (LEDs), fluorescent light sources, incandescent light sources, halogen light sources, or otherwise. In some embodiments, each light source 26 consumes at least about 2 watts of power and/or less than or equal to about 3 watts of power. In certain embodiments, each light source 26 consumes less than or equal to about 3 watts of power, such as about 2 watts of power.

In certain embodiments, the width of each light source 26 can be less than or equal to about 10.0 mm. In certain embodiments, the width of each light source 26 can be less than or equal to about 6.5 mm. In certain embodiments, the width of each light source 26 can be less than or equal to about 5.0 mm. In certain embodiments, the width of each light source 26 can be within about 1.0 mm to about 4.0 mm.

The light sources 26 can be configured to mimic or closely approximate natural light with a substantially full spectrum of light in the visible range. In some embodiments, the light sources 26 can have a color temperature of greater than or equal to about 4500 K and/or less than or equal to about 6500 K. In some embodiments, the color temperature of the light sources 26 can be at least about 5500 K and/or less than or equal to about 6000 K. In certain embodiments, the color temperature of the light sources 26 can be within about 100 K of 5700 K.

In some embodiments, the light sources 26 have a color rendering index of at least about 70 and/or less than or equal to about 90. Certain embodiments of the one or more light sources 26 have a color rendering index (CRI) of at least about 80 and/or less than or equal to about 100. In some embodiments, the color rendering index is high, at least about 87 and/or less than or equal to about 92. In some embodiments, the color rendering index is at least about 90. In some embodiments, the color rendering index can be about 85.

In some embodiments, the luminous flux can be at least about 80 lm and/or less than or equal to about 110 lm. In some embodiments, the luminous flux can be at least about 90 lm and/or less than or equal to about 100 lm. In some embodiments, the luminous flux can be about 95 lm.

In some embodiments, the forward voltage of each light source can be at least about 2.4 V and/or less than or equal to about 3.6 V. In some embodiments, the forward voltage can be at least about 2.8 V and/or less than or equal to about 3.2 V. In some embodiments, the forward voltage is about 3.0 V.

In some embodiments, the illuminance at an outer periphery of the sensing region can be at least about 500 lux and/or less than or equal to about 1000 lux, preferably between about 600 K and about 700 K. The illuminance level can be higher at a distance closer to the face of the mirror. In some embodiments, the illuminance at an outer periphery of the sensing region can be about 700 lux. In some embodiments, the illuminance at an outer periphery of the sensing region can be about 600 lux. Many other sensing regions can also be utilized, some examples of which are described below. In certain variants, the mirror assembly 2 can include a dimmer to adjust the intensity of the light.

In some embodiments, the light sources 26 can be configured to provide multiple colors of light (e.g., each light source can produce a different color) and/or to provide varying colors of light (e.g., each light source can vary in color). For example, the light sources 26 can provide two or more discernible colors of light, such as red light and yellow light, or provide an array of colors (e.g., red, green, blue, violet, orange, yellow, and otherwise). In certain embodiments, the light sources 26 can be configured to change the color or presence of the light when a condition is met or is about to be met. For example, certain embodiments momentarily change the color of the emitted light to advise the user that the light is about to be deactivated.

The mirror assembly 2 can include a mechanism to actively or passively dissipate, transfer, or radiate heat energy away from the light sources 26, such as a fan, vent, and/or one or more passive heat dissipating or radiating structures. As shown in FIG. 6, the mirror assembly can include one or more heat dissipating structures 84. For example, the heat dissipating structures 84 can be positioned near the light sources 26. As shown in FIG. 6, a light source 26 can be secured to each heat dissipating structure 84, for example, near a bottom portion of each heat dissipating structure 84. In certain aspects, the heat dissipating structures 84 can be positioned substantially parallel to each other. In certain aspects, the heat dissipating structures 84 can be positioned at an angle relative to each other, for example, an angle of less than or equal to about 45° or less than or equal to about 30°.

The heat dissipating structures 84 can be formed of materials with a high rate of heat conduction, such as a metal (e.g., aluminum or steel), to help remove heat from the mirror assembly 2 that is generated by the light sources 26. Many other heat dissipating materials, such as copper or brass, can be used.

The heat dissipating structures 84 can dissipate heat created by the light sources 26 and/or conduct electricity to the light sources 26. The heat dissipating structures 84 that both dissipate heat and conduct electricity to the light sources 26 reduce the total number of necessary components. In some embodiments, as shown in FIG. 6, the heat dissipating structures 84 can include one or more components that are generally comparatively long in one dimension, generally comparatively wide in another dimension, and generally comparatively narrow in another dimension, to provide a large surface area over a thin surface to conduct heat efficiently through the heat dissipating structures 84 and then readily transfer such heat into the surrounding air and away from heat-sensitive electronic components in the mirror assembly. For example, the length of a heat dissipating structure 84 can be substantially greater than the width of the heat dissipating structure 84, and the width of the heat dissipating structure 84 can be substantially greater than the thickness of the heat dissipating structure 84.

The heat dissipating structures 84 can be electrically connected circuit boards and/or can provide electric power and signals to the light sources 26 attached directly or indirectly thereto. In some embodiments, the temperature of the light sources 26 with the heat dissipating structures 84 can be sufficiently low to operate efficiently and avoid component damage, such as less than or equal to about 70° F. In some embodiments, the temperature of the light sources 26 with the heat dissipating structures is greater than or equal to about 50° F. and/or less than or equal to about 60° F.

As described above, the mirror assembly 2 can include a number of light conveying structures. The mirror assembly 2 can include a light path along which light can be directed. For example, as shown in FIG. 5, the mirror assembly 2 can include light pipe 32. The light pipe 32 can include acrylic, polycarbonate, or any other clear or highly transmissive material. The light pipe 32 can be at least slightly opaque. As another example, the light path may just be a recessed portion of another structure.

The light pipe 32 can surround at least a majority of the periphery of the mirror 4, substantially the entire periphery of the mirror 4, or the entirety of the periphery of the mirror 4. In some embodiments, the light pipe 32 can be generally circular. In some embodiments, the light pipe 32 can be substantially linearly shaped, or the light pipe 32 can have a non-linear and non-circular shape.

The light pipe 32 can have a radial width and an axial depth. Some variants have a radial width that is greater than or equal to than the axial depth. In certain implementations, the light pipe 32 can be configured to provide adequate area for the reflecting surface of the mirror 4 and to provide sufficient area for light to be emitted from the light pipe 32, as will be discussed in more detail below. For example, the ratio of the radial width of the light pipe 32 to the radius of the mirror 4 can be less than or equal to about: ⅕, 1/15, 1/30, 1/50, values in between, or otherwise.

The light sources 26 can be positioned to transmit light generally toward, or into, the light pipe 32. For example, the light pipe 32 can include an opening in which the light sources 26 can be disposed. A first light source can emit light into a first end of the light pipe 32, and a second light source can emit light into a second end of the light pipe 32.

The light can pass along and through at least a portion of the light pipe 32 and/or emit from the light pipe 32 via an outer face of the light pipe 32. In some embodiments, the light pipe 32 can be configured to transmit at least about 95% of the light emitted from the light sources 26. The light sources 26 can be configured, in combination with light pipe 32, to emit light generally around the periphery of the mirror 4. The light pipe 32 can be configured to disperse light from the light sources 26 through the light pipe 32. The light sources 26 and the light pipe 32 can be configured such that the amount of light emitted from the outer face is substantially constant along the length of the light pipe 32. Many different ways of achieving a substantially constant intensity of conveyed light around the light pipe 32 can be used.

The light pipe 32 can include features to facilitate generally even or uniform diffusion, scattering, and/or reflection of the light emitted by the light sources 26 around the periphery of the mirror. For example, the light pipe 32 can include an irregular anterior and/or posterior surface that is molded in a non-flat and/or non-planar way, etched, roughened, painted, and/or otherwise surface modified. The light scattering elements can be configured to disperse a substantially constant amount of light along the periphery of the mirror 4. These features can help achieve high energy-efficiency, reducing the total number of light sources necessary to light substantially the entire periphery of the mirror and reducing the temperature of the mirror assembly 2.

The light pipe 32 can comprise a generally translucent material with varying degrees of scattering, such that low or minimum amount of scattering occurs in a region near the light sources and high or maximum scattering occurs in a region of the light pipe 32 that is located furthest from the light sources. The light pipe 32 can comprise a region configured to scatter light in a varying manner. In some embodiments, the light conveying pathway or light pipe 32 can comprise a varying, non-constant, non-smooth anterior, posterior, and/or interior surface formed from any suitable process, such as molding, etching, roughening painting, coating, and/or other methods. In some embodiments, one or more surface irregularities can be very small bumps, protrusions, and/or indentations.

The light scattering elements can be less dense near the light sources 26 and become increasingly dense as a function of increased distance from the light sources 26. Such a configuration can, for example, reduce the amount of light that is scattered or reflected (and thus exits the outer face) in areas having generally increased light volume or light intensity, such as portions of the light pipe 32 that are near the light sources 26. Further, such a configuration can encourage additional scattering or reflection (and thus increase the amount that exits the outer face) in areas having generally decreased light volume or intensity, such as at portions of the light pipe 32 that are spaced away from the light sources 26. Accordingly, the mirror assembly 2 can avoid bright areas at some portions of the periphery of the mirror 4 and dark areas at other portions. The mirror assembly 2 can have a substantially constant amount of light emitted along some, substantially all, or all of the periphery of the mirror 4.

In some embodiments, light passing through the light pipe 32 can be scattered at a plurality of different intensity levels, depending on the location of the light within the light pipe 32. For example, light at a first location on the light pipe 32 can be scattered at a first intensity level, light at a second location on the light pipe 32 can be scattered at a second intensity level, and light at a third location on the light pipe 32 can be scattered at a third intensity level, with the third intensity level being more than the second intensity level, and the second intensity level being more than the first intensity level, etc. Many other levels of scattering and many ways of spatially increasing or decreasing scattering can be used instead of or in addition to providing macro scattering elements, such as spatially varying a level of die or a frosting effect within the material of the light pipe 32, or by spatially varying scattering particles embedded within the material, or by spatially varying a surface pattern on one or more outside surfaces of the material.

The light scattering elements can be dispersed in an irregular pattern, such that the light scattering pattern in a first region is different than a light scattering pattern in a second region. A distance between a first light scattering element and a second light scattering element can be different than a distance between a first light scattering element and a third light scattering element.

The sizes (e.g., the diameter) of the light scattering elements can be varied. In some variants, the light scattering elements near the light sources 26 can have a smaller size when compared to light scattering elements that are farther from the light sources 26. For example, the light scattering elements can include a smaller diameter near the light sources 26 and become increasingly larger as a function of distance from the light sources 26. Such a configuration allows substantially even reflection of light to the outer surface. In certain embodiments, each light scattering element can have a diameter of less than or equal to about one millimeter. In some embodiments, the light scattering elements each have a diameter greater than or equal to about one millimeter.

In some embodiments, the light scattering elements can be generally circular. In some embodiments, the light scattering elements have other shapes, such as generally square, generally rectangular, generally pentagonal, generally hexagonal, generally octagonal, generally oval, and otherwise. In certain embodiments, the pattern in the light pipe 32 can include a series of lines, curves, spirals, or any other pattern. In certain embodiments, the light scattering elements can be white. The light scattering elements can be dispersed such that the light pipe 32 appears frosted. In some embodiments, the light scattering elements are not easily visible to the user. For example, the light pipe 32 can be slightly opaque to conceal the appearance of the surface pattern. In some embodiments, the light scattering elements are visible to the user, the light pipe 32 can be clear to show the general color and pattern of the surface elements. In certain embodiments, the light scattering elements can be white.

The light pipe 32 can include a reflective material to achieve high reflectivity. For example, the light pipe 32 can include a reflective backing material 64 along the rear side of the light pipe (see FIG. 7A). In some embodiments, the reflective material 64 can reflect at least about 95% of light. In some embodiments, the reflective material 64 reflects at least about 98% of light. The reflective material 64 can be optically reflective paper.

In certain embodiments, the mirror assembly 2 can include a diffuser 34 (see FIGS. 5 and 7A). The diffuser 34 can be positioned on the surface of the light pipe 32 and/or around the periphery of the mirror 4. For example, the diffuser 34 can be positioned between the light pipe 32 and the user to provide a diffuse, scattered light source, not a focused, sharp light source, which would be less comfortable on the user's eyes. In some embodiments, the transmissivity of the diffuser can be substantially constant around its perimeter or circumference. In some embodiments, the diffuser 34 can surround a majority of the periphery of the mirror 4, substantially the entire periphery of the mirror 4, or the entire periphery of the mirror 4. In some embodiments, as shown in FIG. 5, the diffuser 34 can surround generally the same portion of the periphery of the mirror 4 as the light pipe 32. The diffuser 34 can include an at least partially opaque material. For example, the diffuser 34 can include optical grade acrylic.

The diffuser 34 can include an irregular anterior and/or posterior surface formed from etching, roughening, painting, and/or other methods of surface modification. For example, the diffuser 34 can include a pattern of light scattering elements created using any of the methods discussed herein. The light scattering elements can be modified to include any of the shapes and/or sizes discussed in connection with the light pipe 32.

The light scattering elements can be configured to create soft light by further scattering the light. For example, the light scattering elements can include a plurality of dots having the same diameter or different diameters. In some embodiments, the light scattering elements can be evenly dispersed across the diffuser 34. In other embodiments, the light scattering elements can be randomly dispersed across the diffuser 34, depending on the desired light effect.

In some embodiments, as shown in FIG. 7B, the mirror assembly 2 can include a lens 8. The lens 8 can include a glass or plastic material, such as Makrolon®. The one or more light sources 26 can be disposed between the lens 8 and the outer portion 20. As shown in FIG. 2, a front surface of the lens 8 can be substantially coplanar with the mirror 4. In other embodiments, the front surface of the lens 8 can be positioned at an angle relative to the mirror 4.

In certain embodiments, the mirror assembly 2 can include one or more indicators configured to issue a visual, audible, or other type of indication to a user of the mirror assembly 2 regarding a characteristic of the mirror assembly 2, the user, and/or the relationship between the mirror assembly 2 and the user. For example, the indicator can indicate on/off status, battery levels, imminent deactivation, charging status, and/or a certain mode of operation. The indicator can be used for other purposes as well.

As shown in FIG. 6, the indicator can be an indicator LED 28. The color of the indicator light can vary depending on the indication. For example, the indicator can emit a green light when the mirror assembly is turned on and/or a red light when the battery is running low.

The indicator LED 28 can be disposed at any position along or within the mirror assembly 2. As shown in FIG. 6, the indicator LED 28 can be disposed near the light sources 26. The mirror assembly 2 can include a light conveying structure or pipe 30 for conveying the light transmitting from the indicator LED 28 to a window 10 secured to the lens 8.

As shown in FIG. 6, the mirror assembly 2 can include one or more sensors 46. The sensor 46 can be configured to send a signal to a controller 52 for controlling the operation of the light sources 26 and/or heating element 50. The controller 52 can include one or a plurality of circuit boards (PCBs), which can provide hard-wired feedback control circuits, a processor, and/or memory devices for storing and performing control routines, or any other type of controller. The controller 52 can be disposed between the inner portion 18 and the outer portion 20 of the housing and secured to one or both of the inner and outer portions 18, 20. For example, as shown in FIG. 7A, the controller 52 can be secured to the rear portion 22 of the outer portion 20 and a rear portion 70 of the inner portion 18 with a connector, such as a plurality of screws.

Referring back to FIG. 6, the sensor 46 can be positioned near the light sources 26. In certain aspects, the sensor 46 can be positioned at a location and angled in a direction that is optimal for detecting the object (e.g. the user). For example, the sensor 46 can be positioned along a lower portion of the mirror assembly 2. This may be preferable if an upper portion of the mirror is positioned at a height that is taller than that of the user. The sensor 46 can also be recessed from the front surface of the mirror assembly 2 (e.g., an upper portion or side portion). For example, the sensor 46 can also be positioned between the lens 8 and the outer portion 20. Alternatively, the sensor 46 can be disposed along any other portion of the mirror assembly 2 or not positioned on the mirror assembly 2. For example, the sensor 46 can be positioned near an upper portion of the mirror 4 or along a side portion of the mirror 4. As another example, the sensor 46 can be positioned at another location in the shower.

Although the examples provided in this specification are generally described in connection with only one sensor, the mirror assembly 2 can include multiple sensors 46, for example, to increase a sensing region area, define different sensing regions, or initiate different functions based on the triggered sensor.

In some embodiments, the sensor 46 can be a proximity sensor, such as a capacitive sensor or a reflective-type sensor that can be triggered when an object (e.g., a body part) is moved into, and/or produces movement within, the sensing region. The sensing region can be generally located in front of the reflective mirror 4. When the sensor 46 detects an object, the sensor 46 can trigger a mirror function described herein, such as turning on the light sources and/or initiating the anti-fog features.

For example, the sensor 46 can be a capacitive proximity sensor. The capacitive proximity sensor can produce an electrostatic field. When an object nears a sensing surface, the object can enter the electrostatic field and change the capacitance in an oscillator circuit, which begins oscillating. When the trigger circuit detects a certain level of oscillation, the sensor 46 can send a signal to the controller 52 to activate a mirror function.

As another example, the sensor 46 can include a transmitter and a receiver. The transmitter can be an emitting portion (e.g., for electromagnetic energy such as infrared light), and the receiver can be a receiving portion (e.g., for electromagnetic energy such as infrared light). The transmitter and receiver can be integrated into the same sensor or configured as separate components. The beam of light emitting from the transmitter can define a sensing region. If the receiver detects reflections (e.g., at or above a threshold level) from an object within the beam of light emitted from the transmitter, the sensor 46 can send a signal to the controller 52 to activate a mirror function. In certain variants, the transmitter can emit other types of energy, such as sound waves, radio waves, or any other signals.

Although the mirror assemblies described in this specification are generally disclosed in combination with proximity sensors, other types of sensors can be used, for example, tactile sensors that are sensitive to touch, such as a piezoresistive, piezoelectric, capacitive, or elasto-resistive sensor, that can be triggered when an object contacts a contact surface. The contact surface can include at least a portion of the mirror assembly 2, for example, at least a portion of the periphery of the mirror assembly 2, at least a portion of the mirror 4, at least a portion of a light conveying structure, and/or at least a portion of the wall mount 14. In certain embodiments, the contact surface can include the entire mirror assembly 2. When the sensor 46 detects an object, the sensor 46 can trigger a mirror function described herein, such as turning on the light sources and/or initiating the anti-fog features. In other examples, the sensor can be a temperature sensor, a moisture sensor, a sound sensor, or otherwise.

An algorithm can trigger a mirror function when an object is detected within a predetermined range of distances in a perpendicular forward direction from the front face of the mirror. In some embodiments, an ideal sensing region can be designed so that the sensor is only triggered when the user intends to use the mirror. Thus, the sensing region can be limited such that the sensor is not triggered simply because a person is standing in the shower. For example, in some embodiments, the sensing region extends less than or equal to about 6 inches, less than or equal to about 5 inches, less than or equal to about 4 inches, less than or equal to about 3 inches, less than or equal to about 2 inches, or less than or equal to about 1 inch, along an axis extending from the sensor 46. The axis can be generally perpendicular to the image reflecting surface of the mirror.

If the mirror is used in other settings, for example, in a bathroom, but outside the shower, the ideal sensing region may be different than described above (e.g., larger than any of these values). For example, the sensing region may be configured such that the center of a user's face is generally positioned at about the center of the mirror portion, at a suitable perpendicular distance away from the mirror to permit the user to generally closely fit the user's face within the outer periphery of the mirror. In some embodiments, the sensing region can be at least about 6 inches and/or less than or equal to about 12 inches from the face of the mirror. For example, the ideal sensing region can be at least about 8 inches, at least about 9 inches, at least about 10 inches, or at least about 11 inches, values in between any of these values, or otherwise, from the face of the mirror. In some embodiments, if the sensor is positioned at an upper portion of the mirror assembly, the sensing region can be tilted downwardly at an angle below horizontal (e.g., at least about 10 degrees downward, such as about 15 degrees downward). If the sensor is positioned at a lower portion of the mirror assembly, the sensing region can be tilted upwardly at an angle above horizontal (e.g., at least about 10 degrees upward, such as about 15 degrees upward)

In some embodiments, the sensing region can have a range from at least about 0 degrees to less than or equal to about 45 degrees relative to an axis extending from the sensor 46, and/or relative to a line extending generally perpendicular to a front surface of the sensor(s), and/or relative to a line extending generally perpendicular to the front face of the mirror and generally outwardly toward the user from the top of the mirror assembly. In certain embodiments, the sensing region can have a range from at least about 0 degrees to less than or equal to about 25 degrees relative to any of these axes or lines. In certain embodiments, the sensing region can have a range from at least about 0 degrees to less than or equal to about 15 degrees relative to any of these axes or lines. The sensing region may extend upward or downward depending on the placement of the sensor and likely position of the user relative to the sensor.

In some embodiments, the sensing region can be adjusted by mounting the sensor 46 at an angle. In certain embodiments, the sensor 46 can be mounted such that the front surface of the sensor 46 can be generally parallel or coplanar with a front surface of mirror 4. In certain embodiments, the sensor 46 can be mounted such that the front surface of the sensor 46 can be at an angle relative to the front surface of the mirror.

In some embodiments, the sensing region can be adjusted by modifying one or more features (e.g., shape or angle) of the lens 8. In certain embodiments, the lens 8 can include a lens material. In certain embodiments, the lens 8 can include a generally rectangular cross-section. In certain embodiments, the lens 8 can include a generally triangular cross-section or other shape. In certain embodiments, the lens 8 can include a front surface generally parallel or coplanar with a front surface of the mirror 4. In certain embodiments, the lens 8 can include a front surface at an angle relative to the front surface of the mirror 4. In certain embodiments, the front surface of the lens 8 can be positioned at an angle relative to the sensor 46.

In some embodiments, the sensing area can generally widen as the front surface of the lens 8 moves from the configuration generally parallel or coplanar with the front surface of the mirror 4 to the configuration at an angle relative to the front surface of the mirror 4. In certain embodiments, when the front surface of the lens 8 is generally parallel or coplanar with the front surface of the mirror, the sensing region can have a range from about 0 degrees to about 15 degrees downward relative to the axis extending generally from the sensor 46 and/or generally perpendicular to the front surface of the sensor(s). In certain embodiments, when the front surface of the lens 8 is at an angle relative to the front surface of the mirror 4, the sensing region can have a range from about 0 degrees to about 25 degrees downward relative to the axis extending generally from the sensor 46 and/or generally perpendicular to the front surface of the sensor(s).

In some embodiments, the mirror assembly 2 can include an algorithm configured to control the mirror functions (e.g. light or anti-fog features) based on the detected signal. For example, the algorithm can control the activation and deactivation of the mirror function and/or the intensity of the mirror function. As another example, the algorithm can be configured to trigger one or more modes of operation (discussed in further detail below).

In some embodiments, the algorithm can filter the signal obtained by the sensor. For example, if the mirror assembly 2 includes a proximity sensor or a tactile sensor, the algorithm can be configured to distinguish between a human and water droplets. This algorithm diminishes the risk that a mirror function, such as a lighting function or a heating function, may accidently turn on in the presence of water droplets alone.

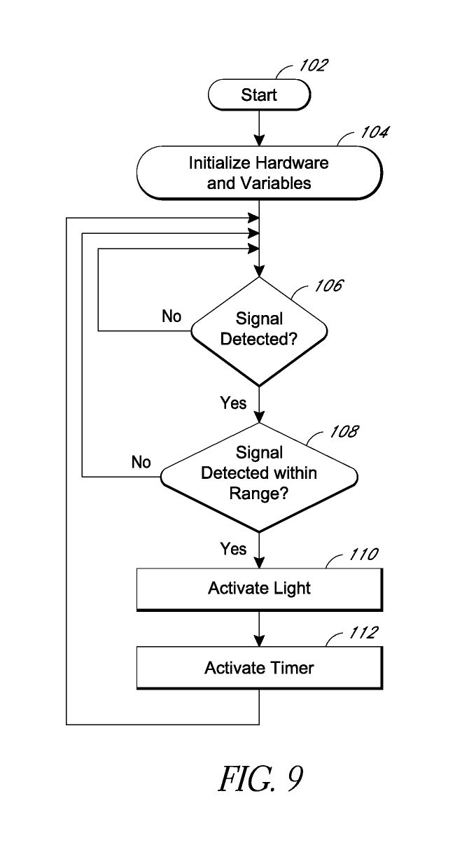

FIG. 9 illustrates an exemplary algorithm for operating the mirror assembly. For example beginning at start (block 102), the mirror assembly 2 initializes the hardware and variable (block 104). For example, this process can begin when the power button 58 is turned on. Once the sensor 46 detects an object (block 106), the algorithm can determine whether the signal is within a pre-determined signal range (block 108). The pre-determined range can be programmed to distinguish a human body part from water droplets. If the detected signal is within the pre-determined signal range, then the sensor 46 signals the controller 52 to activate one or more mirror functions (block 110). The mirror functions can include activating the light sources 26 and/or turning on the heating element 50. Once the mirror function has been activated, a timer can initialize (block 112) for a pre-determined amount of time. When the amount of time elapses, the mirror function can automatically turn off. After the mirror function has been turned off, if the sensor 46 detects a signal within the signal range (blocks 106, 108), the mirror function can be re-activated (block 110). The algorithm may not include all of the blocks described above, or it may include more decision blocks to account for parameters as described throughout this disclosure.

The sensor 46 can send different signals to the controller 52 based on the signal received by the sensor 46 (e.g., amount of light reflected back toward the receiver or amplitude of oscillation). For example, different signals can trigger different mirror functions (e.g., light or anti-fog features). As another example, the sensor 46 can be configured such that the amount of light emitted by the light sources 26 is proportional to the distance between the mirror 4 and the user. In certain variants, if the user is in a first sensing region, then the controller 52 can cause the one or more light sources 26 to activate from an off state or to emit a first amount of light. If the user is in a second sensing region (e.g., further away from the sensor 46 than the first sensing region), then the controller 52 can cause the one or more light sources 26 to emit a second amount of light (e.g., less than the first amount of light).

In some embodiments, if the user is in a first sensing region, then the controller 52 can activate the first mirror function. If the user is in a second sensing region (e.g., closer to the sensor than the first sensing region), then the controller 52 can activate a second mirror function.

In certain embodiments, the first mirror function can be an anti-fog function and the second mirror function can be emitting light, or vice versa.

In some embodiments, the controller 52 can trigger at least two different levels of brightness from the light sources 26, such as brighter light or dimmer light. For example, if the user is anywhere in a first sensing region, then the controller 52 signals for bright light to be emitted; if the user is anywhere in a second sensing region, then the controller 52 signals for dim light to be emitted.

The controller 52 can also trigger more than two brightness levels. In certain implementations, the level of emitted light is related (e.g., linearly, exponentially, or otherwise) to the distance from the sensor to the user. For example, as the user gets closer to the sensor 46, the one or more light sources 26 emit more light. Alternatively, the mirror assembly 2 can be configured to emit more light when the user is further away from the sensor 46 and less light as the user moves closer to the sensor 46.

In some embodiments, one or more sensors 46 can generate a primary sensing region and a secondary sensing region (or more sensing regions). For example, the mirror assembly can include one sensor having multiple transmitters or multiple sensing surfaces. As another example, the mirror assembly 2 can include more than one sensor, each having a transmitter or a sensing surface. Each transmitter or sensing surface can generate a detection zone subject to the nominal range of that sensor 46. The area in which the two detection zones overlap creates a primary sensing region, and areas in which the two detection zones exist but do not overlap create a secondary sensing region. If a user is detected in the primary sensing region, then the sensor 46 sends an appropriate signal to the controller 52, which triggers a first mirror function or a first level of light from the light sources 26. If a user is detected in the secondary sensing region, then the sensor 46 sends an appropriate signal to the controller 52, which activates a second mirror function or a second level of light from the light sources 26. In some embodiments, the first level of light can be brighter than the second level of light, such that the sensor 46 can trigger brighter light when the user is within a first sensing region, directly in front of the sensor 46, and trigger dimmer light when the user is within a second sensing region, in the periphery of the mirror assembly 2. In other embodiments, the second level of light can be brighter than the first level of light. In some embodiments, the sensor 46 defines more than two sensing regions and triggers more than two levels of light.

The sensor 46 can include two or more transmitters or sensing surfaces that do not create overlapping detection zones. If a user is detected in the first sensing region alone or the second sensing region alone, then the sensor 46 can signal the controller 52 to activate a first mirror function or a first level of light from the light sources 26. In certain variants, if a user is concurrently detected in the first and second sensing regions, then the sensor 46 can signal the controller 52 to activate a second mirror function or a second level of light from the light sources 26. In some embodiments, the first level of light can be brighter than the second level of light. In other embodiments, the second level of light is brighter than the first level of light.

In some embodiments, the different sensing regions can be used to activate different mirror functions. For example, if an object is detected in a first sensing region, then the heating element 50 can activate. If an object is detected in a second sensing region, then the light sources 26 can activate. If an object is detected in a third sensing region, then both the heating element 50 and the light sources 26 can activate. The third sensing region can include a portion of the first and second sensing regions or the third sensing region can be entirely distinct from the first and second sensing regions. The third sensing region can be further from the sensor than the second sending region, and the second sensing region can be further from the sensor than the first sensing region.

The one or more sensing regions can be used in any type of configuration that allows the user to control an aspect of the operation of the mirror assembly 2. The position and/or corresponding signal of the sensing regions is not limited to the examples provided herein. For example, the first and second sensing regions or primary and secondary regions can be inter-changed or their corresponding signals can be interchanged. Any of the one or more sensing regions can be used to trigger the mirror assembly 2 to emit different levels of light, operate for varying durations of time, pivot the mirror, activate different mirror functions, or any other appropriate parameter.

Activation of a mirror function or adjusting the amount of light emitted from the light sources 26 can be based on factors other than the presence of a user within a sensing region. For example, the sensor 46 can be triggered by motion within the detection zone and nominal range of the sensor 46. Certain implementations are configured such that, if a user lifts his/her hand in an upward motion, then the controller 52 signals for the amount of light to increase, and if a user lowers his/her hand in a downward motion, then the controller 52 signals for the amount of light to decrease.

In some embodiments, after a mirror function (e.g., a light-emitting and/or an anti-fog feature) activates, the mirror function can remain activated so long as the sensor 46 detects an object in a sensing region, and/or the mirror function remains activated for a pre-determined period of time. The pre-determined period of time can be programmed for any period of time. For example, the timers can run for less than or equal to about 10 minutes, or less than or equal to about five minutes. In some instances, activating the mirror function can initialize a timer. If the sensor 46 does not detect an object before the timer runs out, then the mirror function can be deactivated. If the sensor 46 detects an object before the timer runs out, then the controller 52 can reinitialize the timer, either immediately or after the time runs out. As another example, the mirror function can automatically power off after the time elapses, even if an object is detected before the time elapses. If it is desirable for each mirror function to operate for different periods of time, each mirror function can include a separate timer. For example, the heating element 50 can operate for a longer time than the light sources 26.

The algorithm can incorporate a delay that deactivates the sensor or otherwise prevents activation of a mirror function immediately after the mirror function deactivates. The delay can be less than or equal to about 1 second, less than or equal to about 5 seconds, or any other amount of time. The delay helps prevent the user from unintentionally triggering the mirror function. During the delay period, the mirror function will not activate even if an object is in a sensing region during the delay period. If the sensor 46 detects an object after the delay period, the mirror function can activate again.

In some embodiments, the duration of the mirror function does not have to depend solely or at all on the length of time that the user remains in the sensing region. The duration of the mirror function can differ depending on the location of the user in a different sensing region, different motions, or otherwise, even if certain other parameters are the same (such as the length of time that the user is sensed in a region).

In several embodiments, the mirror assembly 2 has one or more modes of operation, for example, an on mode and an off mode. A controller 52 can activate different modes based on signals received from different sensing regions, motions, or any other parameter. Any of the modes described below can be used separately or in combination with each other.

The mirror assembly 2 can include a task mode. When the task mode is activated, the mirror assembly 2 can trigger a mirror function to remain activated or cause the sensor to enter a hyper mode (e.g., during which the sensor is configured to have increased sensitivity to movement within a zone, or to have a larger or wider sensitivity zone, or to have some other increased sensitivity signal detection) for a pre-determined period of time. For example, in some embodiments, the task mode can be especially useful when the user plans to use the mirror assembly 2 for an extended period of time, especially if the user's body position is substantially still for an extended period, to avoid intermittent loss of function while the user is still looking into the mirror. The task mode can trigger a mirror function to remain activated for a predetermined amount of time, even if the user is not detected within a sensing region. The pre-determined amount of time can be less than or equal to about: 3 minutes, 5 minutes, 10 minutes, or any other suitable period of time. If the sensor 46 does not detect a user before the timer runs out, then the mirror assembly 2 can deactivate task mode. In certain embodiments, the mirror assembly 2 remains in task mode until the user actively signals a mirror function to deactivate.

The mirror assembly 2 can include a power saver mode. When the power saver mode is activated, the light source 26 can emit less light than the mirror assembly 2 when not in power saver mode. As another example, the power save mode can signal the controller to activate only one mirror function, for example, the heating element 50. The power saver mode can be user-activated and can be used when a user plans to use the mirror for a relatively long period of time. Alternatively, the mirror assembly 2 can enter power saver mode automatically as a transition between on mode and off mode. For example, a controller 52 can initialize a timer when a mirror function activates. If the sensor 46 does not detect a user before the timer runs out, then the controller 52 can enter power saver mode and initialize a second timer. If the sensor 46 does not detect a user before the second timer runs out, then the controller 52 can deactivate the mirror function.

The mirror assembly 2 can include a hyper mode. As described above, in some embodiments, the mirror assembly 2 can emit two sensing regions. In certain implementations, the controller 52 only activates a mirror function when the sensor 46 detects an object in the region where the two sensing regions intersect (e.g., the primary sensing region). In some embodiments, after the mirror function has been activated, the mirror assembly 2 can enter hyper mode. The controller 52 can keep the mirror function activated as long as the sensor(s) detects the user in either one or both of the sensing regions (the secondary or the primary sensing regions). The secondary sensing region can be different from the primary sensing region. For example, the secondary sensing region can be larger than the primary sensing region. In some embodiments, this allows the user to move around and still keep the mirror function activated. Hyper mode can also help save power by preventing unintentional activation when the user is near a periphery of the mirror assembly 2.

The mirror assembly 2 can also include ambient light sensing capabilities. For example, when the ambient light is relatively low, the light emitting from the light source 26 can be brighter than if the ambient light is relatively bright. The receiver can detect both ambient light and light emitted from the transmitter, or the mirror assembly 2 can include a second sensor(s) for detecting ambient light.

The controller 52 can adjust the amount of signal necessary to trigger a mirror function based on the amount of detected ambient light. For example, the amount of detected light required to activate the mirror function can be proportional to the ambient light. Such a configuration can allow the mirror function to be activated even when the level of ambient light is modest (e.g., in dimmed bathroom lighting). When the ambient light is less than or equal to a first level, the controller 52 can activate a mirror function when a first level of the reflected signal is detected. When the ambient light is greater than the first level, the controller 52 can activate the mirror function when a second level (e.g., greater than the first level) of the reflected signal is detected.

The controller 52 can also adjust the amount of light emitted by the light sources 26 based on the ambient light. Such a configuration can, for example, avoid emitting a starting burst of very bright light that would be uncomfortable to a user's eyes, especially when the user's eyes were previously adjusted to a lower light level, such as when the surrounding environment is dim. For example, the amount of light emitted by the light sources 26 can be proportional to the amount of ambient detected light.

The controller 52 can also gradually increase the level of emitted light from the light sources 26 when the light sources 26 are activated and/or gradually decrease the amount of light emitted from the light sources 26 when the light sources 26 are deactivated. Such a configuration can inhibit discomfort to a user's eyes when the light sources 26 turn on.

The mirror assembly 2 can also include a calibration mode. For example, the calibration mode can calibrate the different sensing regions with different output characteristics as desired by the user. An algorithm can be configured to utilize multiple sensing regions to perform different functions. For example, a user can configure a first sensing region to correspond with a first mirror function or a first level of light (e.g., lower intensity light) and configure a second sensing region to correspond with a second mirror function or a second level of light (e.g., higher intensity light). In another example, the user can adjust the size (e.g., width or height) of the sensing region. The user can designate a first sensing region to correspond with a first mirror function or a first level of light and designate a second sensing region to correspond with a second mirror function or a second level of light. This calibration mode can be triggered by a user indicator, such as pressing a button, activating a sensor, or any other appropriate mechanism.

In some embodiments, the mirror assembly 2 can include an algorithm configured to maintain a mirror function at a generally constant level even as the battery capacity is nearing the end of its life (necessitating a recharge) by adjusting the electrical characteristics of the power source supplied to the light source depending on the stage of battery life (e.g., increasing the voltage as the current decreases or increasing the current as the voltage decreases).

In some embodiments, the mirror assembly 2 can include an algorithm configured to detect whether the mirror was inadvertently activated, such as with a false trigger or by the presence of an inanimate object. For example, when the sensor detects an object, the controller 52 can initialize a timer. If the mirror assembly 2 does not detect any movement before the timer runs out, then the light sources will turn off. If the mirror assembly 2 does detect movement, then the timer can re-initialize.

The mirror assembly 2 can be powered by one or more batteries. For example, as shown in FIG. 7A, the mirror assembly 2 can include a battery housing 48 configured to receive one or more batteries. The battery housing 48 can be disposed between the mirror 4 and the inner portion 8 of the housing 8. However, the battery housing 48 can be positioned elsewhere, for example, between the inner portion 18 and the outer portion 20, between the outer portion 20 and the joint portion 16, between the joint portion 16 and the wall mount 14, or entirely within the wall mount 14.

In some embodiments, the mirror assembly 2 can consume less than or equal to about 5 watts of power, less than or equal to about 3 watts of power, or less than or equal to about 2 watts of power. In some embodiments, the battery can deliver power to the light sources 26 and/or the anti-fog components for at least about ten minutes per day for about thirty days (e.g., at least about 2000 minutes). The battery can be, for example, a battery that discharges about 6.6 A.

To save power, the mirror assembly 2 can include one or more power-saving features. For example, the sensor 46 can operate in a pulsating mode. The sensor 46 can be powered on and off in a cycle such as, for example, for short bursts lasting for any desired period of time (e.g., less than or equal to about 0.01 second, less than or equal to about 0.1 second, or less than or equal to about 1 second) at any desired frequency (e.g., once per half second, once per second, once per ten seconds). Cycling can greatly reduce the power demand for powering the sensor 46. In operation, cycling does not degrade performance in some embodiments because the user generally remains in the path of the light beam long enough for a detection signal to be generated.

As another power-saving feature, the mirror assembly 2 can include a feature to deactivate the light sources 26, sensor 46, and/or anti-fog features. As described above, any of these features can be turned off automatically when a timer elapses. In some embodiments, one or more of these features can be user-deactivated. The mirror assembly 2 can include one or more deactivation sensors (not shown) similar to any of the sensors described herein, for example, a proximity sensor or a tactile sensor. When the deactivation sensor detects an object, the deactivation sensor can signal the controller 52 to deactivate or supply less power to the light sources 26, sensor 46, and/or anti-fog components. The deactivation sensor can be positioned anywhere along the mirror assembly 2, preferably at a location sufficiently displaced from the sensor 46 so as to avoid accidental activation of one of the sensors. For example, if the sensor 46 is positioned at a lower portion of the mirror assembly 2, the deactivation sensor can be positioned along at least a portion of the periphery of the mirror assembly 2 or along the wall mount.

The mirror assembly 2 can also include one or more power buttons to turn power on and off the sensor 46 or heating element 50. The power buttons can be positioned anywhere on the mirror assembly 2. For example, as described above and shown in FIG. 4B, the mirror assembly 2 can include a power button 58 on the rear portion 22 of the housing 8. To access the power button 58, the user can remove the cap 36, joint portion 16, and/or wall mount 14. As another example, the power button 58 can be positioned along a different portion of the housing 8, along the wall mount 14, or along a user facing surface of the mirror assembly 2.

In some embodiments, one or more components of the mirror assembly 2 can be detached to replace the batteries. In some embodiments, the battery can be recharged via a port 90 (e.g., a universal serial bus (USB) or otherwise). The port 90 can be configured to permanently or removably receive a connector coupled with a wire or cable (not shown). The port 90 can also be configured to allow electrical potential to pass between the battery and a power source via the connector. As shown in FIG. 4B, the port 90 can be disposed along a rear portion 22 of the housing 8. In use, the user can remove the cap 36 or other components connected to the rear portion 22, such that the user can plug a cable into the port 90 to recharge the battery.

In some embodiments, a separable pod can be selectively and repeatedly attached and removed from the mirror assembly 2, the pod comprising a rechargeable battery, a memory component, and/or a microprocessor, without requiring detachment or reattachment of the mounting structure of the mirror assembly 2 to a wall or other mounting location. The port 90 can be positioned on the detachable pod of the mirror assembly 2.

Additionally, the port 90 may be used to program or calibrate different operations, such as mirror illumination, object sensing, anti-fog features, or power features, when connected to a computer. Data can be transferred between the computer and the mirror assembly via the port 90. The mirror assembly can be configured to communicate with a computer wirelessly, such as by using cellular, Wi-Fi, or Bluetooth® network, or infrared communication.

The mirror assembly can include memory, such as firmware, to store the various control schemes and algorithms, as well certain instructions and/or settings related to various characteristics of the mirror assembly. For example, the memory can include instructions and/or variable or permanent settings regarding the size of the sensing regions, the sensitivity of the sensors, the level of illumination, the length of various timers, power output, or other features.

In some embodiments, although not shown, the mirror assembly 2 can include a speaker. The speaker can output audio files stored on the memory or received wirelessly.

When the mirror assembly is in communication with the computer, a control panel can be displayed on the computer. The control panel permits the user to adjust various inputs and output characteristics for the mirror assembly. For example, a user can use the control panel to adjust the size of the sensing regions or the sensitivity of the sensors. As another example, the user can also configure the level of illumination, light timers, anti-fog timers, power usage, or otherwise. For example, the user can use the control panel to modify the operation and output (e.g., intensity and/or color of the light) of the light source based on certain conditions, such as the time of day, level of ambient light, amount of battery power remaining, and otherwise. In certain variants, the ability to modify the operational parameters of the mirror assembly with the control panel can reduce or obviate the need for one or more adjustment devices (e.g., buttons, knobs, switches, or the like) on the mirror assembly, thereby providing a generally smooth, uniform, and/or uninterrupted exterior surface of the mirror assembly (which can facilitate cleaning) and reducing the chance of unintentional adjustment of the operational parameters (such as when transporting the mirror assembly).

When the mirror assembly is in communication with the computer, data can be transferred from the mirror assembly to the computer. For example, the mirror assembly can transfer data, such as power consumption, estimated remaining battery power, the number of activations and/or deactivations of the light source, the length of use (e.g., of individual instances and/or in total) of the light source, and otherwise. Software can be used to analyze the transferred data, such as to calculate averages, review usage statistics (e.g., during specific periods), recognize and/or draw attention to unusual activity, and display usage statistics on a graph. Transferring usage statistics from the mirror assembly to the computer allows the user to monitor usage and enables the user to calibrate different characteristics of the mirror assembly (e.g., based on previous usage and parameters). Transferring data from the mirror assembly to the computer can also reduce or avoid the need for one or more adjustment or display devices on the mirror assembly itself.

When the mirror assembly is in communication with the computer, the computer can also transfer data to the mirror assembly. Furthermore, when the mirror assembly is in communication with the computer, electrical potential can be provided to the battery before, during, or after such two-way data transfer.

### TERMINOLOGY

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The terms “about,” “generally,” and “substantially” as used herein represent an amount close to the stated amount that still performs a desired function or achieves a desired result. For example, as the context may dictate, the terms “about,” “generally,” and “substantially” may refer to an amount that is within less than or equal to about 10% of the stated amount. The term “generally” as used herein represents a value, amount, or characteristic that predominantly includes or tends toward a particular value, amount, or characteristic. As an example, in certain embodiments, as the context may dictate, the term “generally parallel” can refer to something that departs from exactly parallel by less than or equal to 20 degrees.

The ranges disclosed herein also encompass any and all overlap, sub-ranges, and combinations thereof. Language such as “up to,” “at least,” “greater than,” “less than,” “between” and the like includes the number recited. Numbers preceded by a term such as “about” or “approximately” include the recited numbers. For example, “about 6 inches” includes “6 inches.”

Some embodiments have been described in connection with the accompanying drawings. However, it should be understood that the figures are not drawn to scale. Distances, angles, etc. are merely illustrative and do not necessarily bear an exact relationship to actual dimensions and layout of the devices illustrated. Components can be added, removed, and/or rearranged.

Although the mirror has been disclosed in the context of certain embodiments and examples, it will be understood by those skilled in the art that the present disclosure extends beyond the specifically disclosed embodiments to other alternative embodiments and/or uses of the subject matter and obvious modifications and equivalents thereof. In addition, while several variations of the mirror have been described in detail, other modifications, which are within the scope of the present disclosure, will be readily apparent to those of skill in the art based upon this disclosure. It is also contemplated that various combinations or sub-combinations of the specific features and aspects of the embodiments can be made and still fall within the scope of the present disclosure. Additionally, it will be recognized that any methods described herein may be practiced using any device suitable for performing the recited steps. Thus, it is intended that the scope of the subject matter herein disclosed should not be limited by the particular disclosed embodiments described above. None of the features described herein are essentially or indispensable. Any feature, structure, or step disclosed herein can be replaced with or combined with any other feature, structure, or step disclosed herein, or omitted.

1. A mirror assembly comprising:
a housing portion;
a mirror connected to the housing portion;
at least one heating element disposed between the housing portion and the mirror, the at least one heating element configured to heat a surface of the mirror to a pre-determined temperature;
a sensor configured to detect an object within a sensing region; and
an electronic processor configured to generate an electronic signal to activate at least one light source or to activate the element when the sensor detects the object.

2. The mirror assembly of claim 1, wherein the sensor is a proximity sensor.

3. The mirror assembly of claim 1, wherein the sensor is a tactile sensor.

4. The mirror assembly of claim 1, wherein the at least one heating element comprises a thermoelectric cooler.

5. The mirror assembly of claim 1, wherein a surface area of the at least one heating element is less than or equal to about 10% of a surface area of the mirror.

6. The mirror assembly of claim 1, further comprising a heat distribution plate disposed between the mirror and the at least one heating element.

7. The mirror assembly of claim 1, further comprising a heat insulation plate disposed between the housing portion and the at least one heating element.

8. The mirror assembly of claim 1, wherein the pre-determined temperature is greater than or equal to about 26° C.

9. The mirror assembly of claim 1, wherein the pre-determined temperature is adjustable.

10. The mirror assembly of claim 1, wherein the at least one heating element is configured to heat the surface of the mirror to the pre-determined temperature in less than or equal to about two minutes.

11. The mirror assembly of claim 1, wherein the at least one heating element is configured to consume less than or equal to about five watts of power.

12. The mirror assembly of claim 1, wherein the at least one heating element is powered by a battery.

13. The mirror assembly of claim 1, wherein the at least one heating element comprises two heating elements.

14-26. (canceled)

27. A mirror assembly comprising:
a housing portion;
a mirror connected to the housing portion;
at least one thermoelectric cooler disposed between the housing portion and the mirror, the at least one thermoelectric cooler configured to heat a surface of the mirror to a pre-determined temperature.

28. The mirror assembly of claim 27, wherein a surface area of the at least one thermoelectric cooler is less than or equal to about 10% of a surface area of the mirror.

29. The mirror assembly of claim 27, further comprising a heat distribution plate disposed between the mirror and the at least one thermoelectric cooler.

30. The mirror assembly of claim 27, further comprising a heat insulation plate disposed between the housing portion and the at least one thermoelectric cooler.

31. The mirror assembly of claim 27, wherein the pre-determined temperature is greater than or equal to about 26° C.

32. The mirror assembly of claim 27, wherein the pre-determined temperature is adjustable.

33. The mirror assembly of claim 27, wherein the at least one thermoelectric cooler is configured to heat the surface of the mirror to the pre-determined temperature in less than or equal to about two minutes.

34. The mirror assembly of claim 27, wherein the at least one thermoelectric cooler is configured to consume less than or equal to about five watts of power.

35. The mirror assembly of claim 27, wherein the at least one thermoelectric cooler is powered by a battery.

36-50. (canceled)
